(19) United States
(12) Patent Application Publication
(10) Pub. No.: US 2021/0166588 A1
(43) Pub. Date: Jun. 3, 2021

(54) BREATHABLE HEAT TRANSFER LABEL

(71) Applicant: r-pac International Corp., New York, NY (US)

(72) Inventor: Michael Teitelbaum, New York, NY (US)

(21) Appl. No.: 17/167,462

(22) Filed: Feb. 4, 2021

Related U.S. Application Data
(63) Continuation of application No. PCT/US2019/064281, filed on Dec. 3, 2019.

(51) Int. Cl. G09F 3/10; A45C 3/00; B65C 5/04; B65C 9/18; B32B 3/26; B32B 5/02; B32B 27/12; B32B 7/12; B41J 3/407; B41J 11/00; B41J 11/66; G09F 3/02

(52) U.S. Cl. CPC G09F 3/10; G09F 2003/0269; B65C 5/04; B65C 9/1811; B32B 3/266; B32B 5/02; B32B 27/12; B32B 7/12; B41J 3/4078; B41J 11/002; B41J 11/66; B41J 3/4075; G09F 3/02; A45C 2003/007; B32B 2437/00; B32B 2439/06; G09F 2003/0226; G09F 2003/0232; G09F 2003/0282; A45C 3/001

(57) ABSTRACT

Technologies are generally provided for textile items with breathable heat transfer labels. In some examples, a reversed design of a label may be printed onto a surface of a carrier using a water-based or solvent-based ink. A layer of a thermoplastic adhesive may be applied onto the surface of the carrier with the reversed design and a predefined pattern of holes may be laser-drilled into the carrier through the thermoplastic adhesive to avoid appearance of burn marks on an external surface of the label in the completed product. The carrier may be onto a garment or textile item by affixing the thermoplastic adhesive onto a surface of the garment and activating the thermoplastic adhesive. The carrier may then be removed revealing the design of the label with laser-drilled holes on the garment or textile item.

### BACKGROUND

Unless otherwise indicated herein, the materials described in this section are not prior art to the claims in this application and are not admitted to be prior art by inclusion in this section.

Sports apparel and similar performance garments typically include labels that may cover up to an entire exterior surface of the garment. Displaying brand information, team information, or other information, such labels are commonly made from synthetic materials. Thus, even if the garment material itself is includes natural materials or is designed to pass air and moisture to pass through, the label (depending on its size) may prevent “ventilation” and may result in short- or long-term health concerns for the wearers.

### SUMMARY

The present disclosure generally describes breathable heat transfer labels for garments and similar products and methods for producing such products. Employing a laser cut perforation pattern that allows air and moisture to move through the design, heat transfer labels according to embodiments may allow and enhance comfort and ventilation in athletic apparel and similar performance gear.

Embodiments described herein illustrates methods, devices, and systems to overcome challenges of conventional technologies for athletic garments or similar items. In some examples, a reversed design of a label may be printed onto a surface of a carrier using a water-based or solvent-based ink. A layer of a thermoplastic adhesive may be applied onto the surface of the carrier with the reversed design and a predefined pattern of holes may be laser-drilled into the carrier through the thermoplastic adhesive to avoid appearance of burn marks on an external surface of the label in the completed product. The carrier may be onto a garment or textile item by affixing the thermoplastic adhesive onto a surface of the garment and activating the thermoplastic adhesive. The carrier may then be removed revealing the design of the label with laser-drilled holes on the garment or textile item

The foregoing summary is illustrative only and is not intended to be in any way limiting. In addition to the illustrative aspects, embodiments, and features described above, further aspects, embodiments, and features will become apparent by reference to the drawings and the following detailed description. Thus, the foregoing summary is not exhaustive or limiting but rather example of different embodiments non-obvious and unique to a person skilled in the art.

### BRIEF DESCRIPTION OF THE DRAWINGS

The foregoing and other features of this disclosure will become more fully apparent from the following description and appended claims, taken in conjunction with the accompanying drawings. Understanding that these drawings depict only exemplary embodiments in accordance with the disclosure and are, therefore, not to be considered limiting of its scope, the disclosure will be described with additional specificity and detail through use of the accompanying drawings, in which:

FIG. 1A and 1B include illustrations of a garment (t-shirt) with different designs of breathable heat transfer labels;

FIG. 2A through 2D include a conceptual illustration of manufacture of a breathable heat transfer label and its application onto a garment;

FIG. 3 includes a conceptual illustration of the layers of an example breathable heat transfer label;

FIG. 4 includes a conceptual illustration of an example system to manufacture garments with breathable heat transfer labels;

FIG. 5 illustrates major components of an example system for providing garments with breathable heat transfer labels;

FIG. 6 illustrates a computing device, which may be used to manage a system to manufacture garments with breathable heat transfer labels; and

FIG. 7 includes a flowchart of example actions in providing garments with breathable heat transfer labels,

all of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein. Additionally, the sequence of flow of the example embodiments may be changed depending on context of user scenario of specific embodiments.

This disclosure is generally drawn, inter alfa, to methods, apparatus, systems, devices, and/or products related to breathable heat transfer labels for garments and similar products.

Briefly stated, technologies are generally described for textile items with breathable heat transfer labels. In some examples, a reversed design of a label may be printed onto a surface of a carrier using a water-based or solvent-based ink. A layer of a thermoplastic adhesive may be applied onto the surface of the carrier with the reversed design and a predefined pattern of holes may be laser-drilled into the carrier through the thermoplastic adhesive to avoid appearance of burn marks on an external surface of the label in the completed product. The carrier may be onto a garment or textile item by affixing the thermoplastic adhesive onto a surface of the garment and activating the thermoplastic adhesive. The carrier may then be removed revealing the design of the label with laser-drilled holes on the garment or textile item.

Example embodiments are described herein using garments onto which breathable heat transfer labels may be applied. Such garments may include, but are not limited to, shirts, dresses, jackets, coats, skirts, socks, gloves, scarves, headgear, undergarments, shorts, and pants. In some embodiments, the labels may be applied to other types of textile items such as sports bags, bedsheets, curtains, and similar items. The textile items and garments may be made from any suitable material. Design shapes, colors, sizes, and other parameters of the labels may be selected based on desired graphical design (which may include text, graphics, color, holographic images, etc.), textile item or garment type and size, and other implementation specifics such as expected use environment, expected wear and tear, etc.

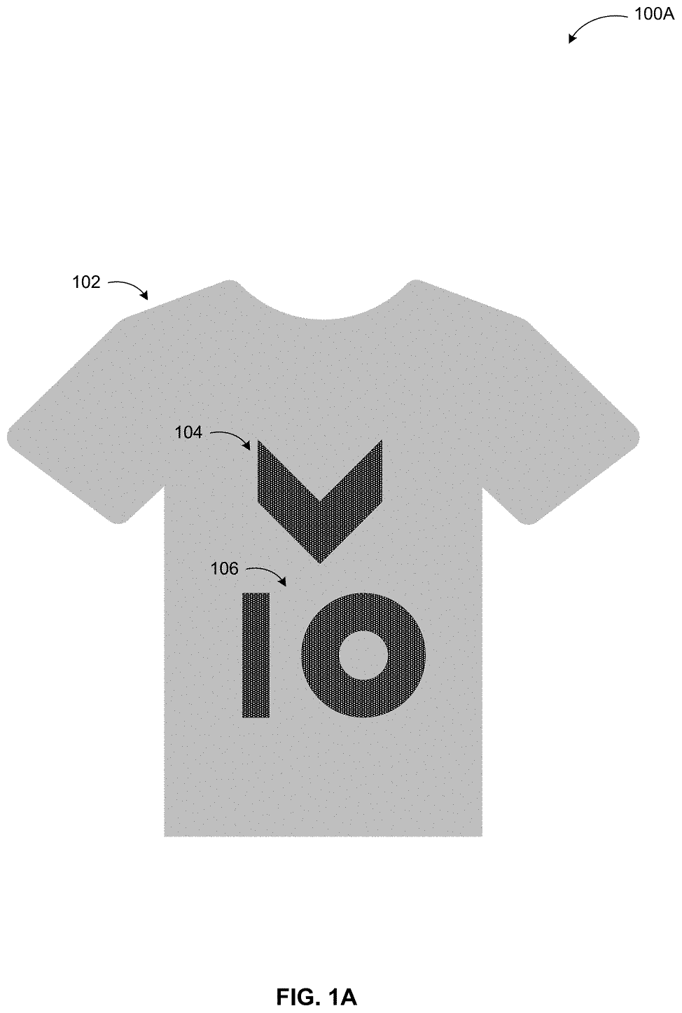

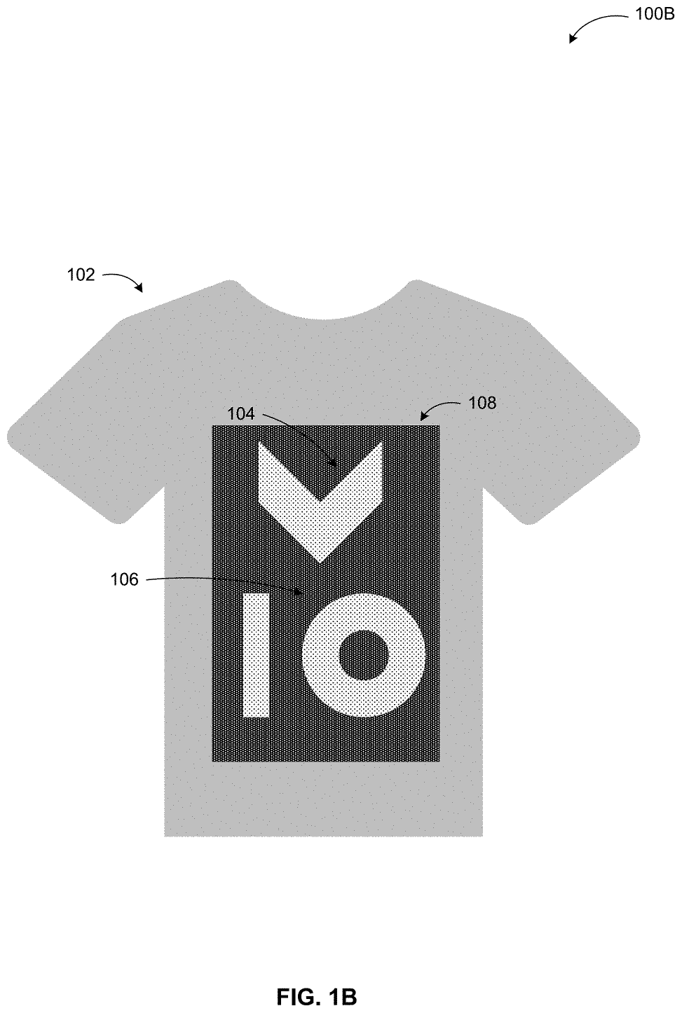

FIG. 1A and 1B include illustrations of a garment (t-shirt) with different designs of breathable heat transfer labels, arranged in accordance with at least some embodiments described herein.

As shown in diagram 100A, a garment 102 may be made from breathable material such as cotton or synthetic material (e.g., polyester) with holes. If a large size label is applied to the garment (e.g., labels 104, 106), a substantial portion of the garment's surface may become unbreathable not allowing air or moisture to pass through. This, in turn, may result in undesirable effects such as confinement of body sweat within the garment, insufficient oxygen being provided to a body of an athlete, etc.

The labels 104, 106 may be breathable labels according to some embodiments formed by printing of a label design through ink onto a carrier, application of a thermoplastic adhesive, and application of the labels onto the garment 102 through activation of the thermoplastic adhesive. Before application of the labels onto the garment, holes may be drilled in the label through laser. Thus, the label when applied onto the garment may pass air and moisture through rendering the garment healthier. The labels 104, 106 are shown as two distinct labels, but they may also be combined. The labels 104, 106 may include text, graphics, images, holograms, etc. A material (i.e., the ink), a size, and a thickness of the labels may be selected based on application (garment type, design) and expected use environment (e.g., expected wear and tear, expected life of the garment, etc.).

Diagram 100B shows a different configuration, where the designs of the labels 104 and 106 are combined into a single label 108 with darker background. As label designs may have a variety of colors and backgrounds, the sizes, pattern, and/or concentration of the holes in the labels may be selected to preserve a visual integrity of the label. In some examples, the sizes, pattern, and/or concentration of the holes may be selected to complement a label design. For example, hole sizes and concentration may be reduced (within functional limits) in the darker background areas of the label and increased in the lighter areas of the label without interfering with the visual integrity of the label.

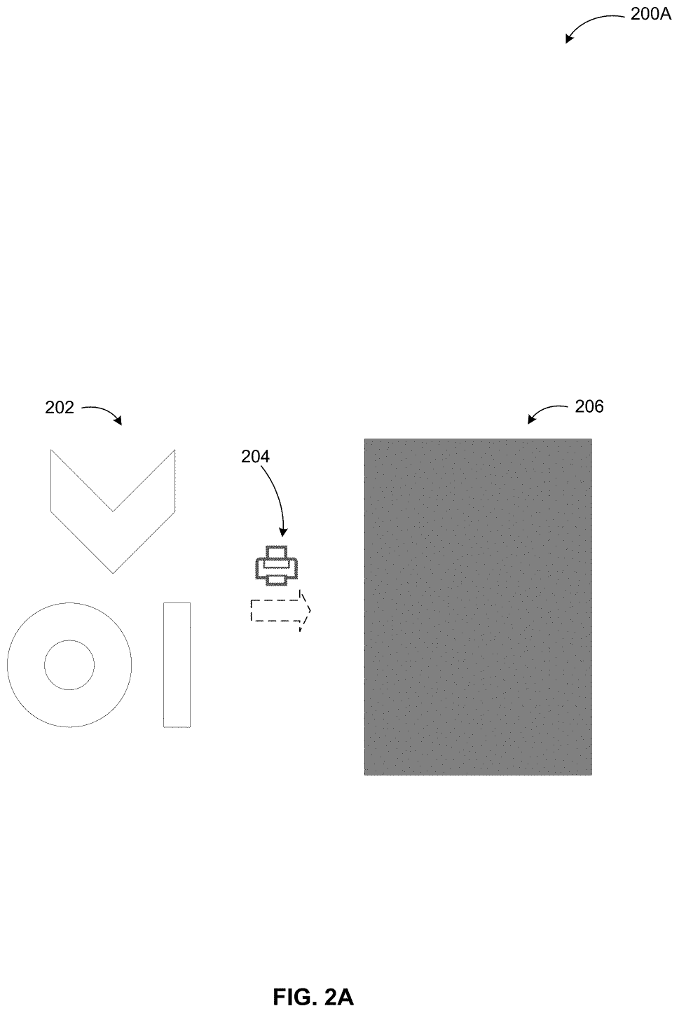

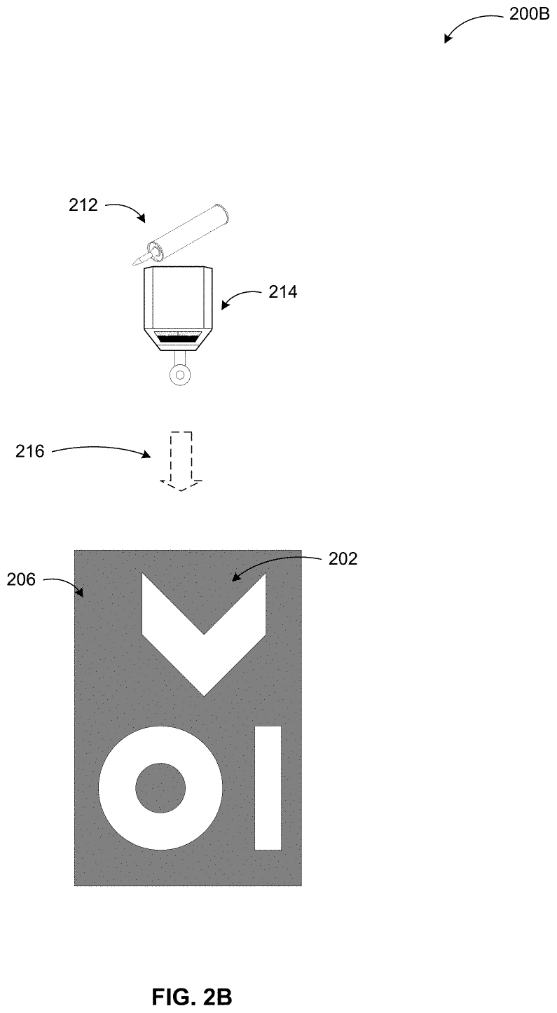

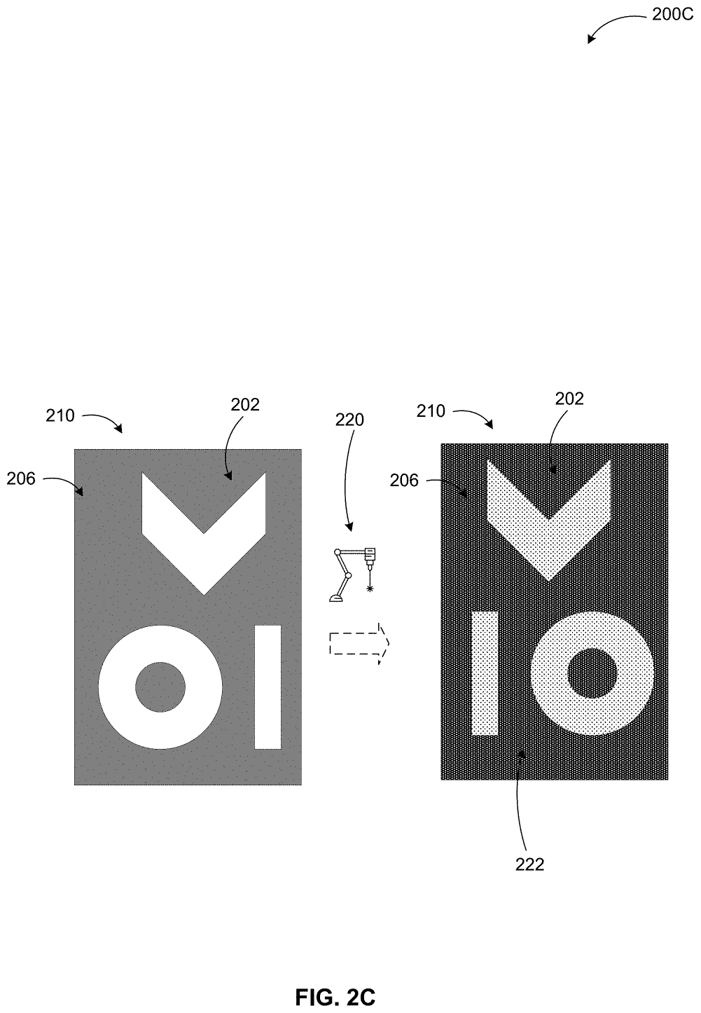

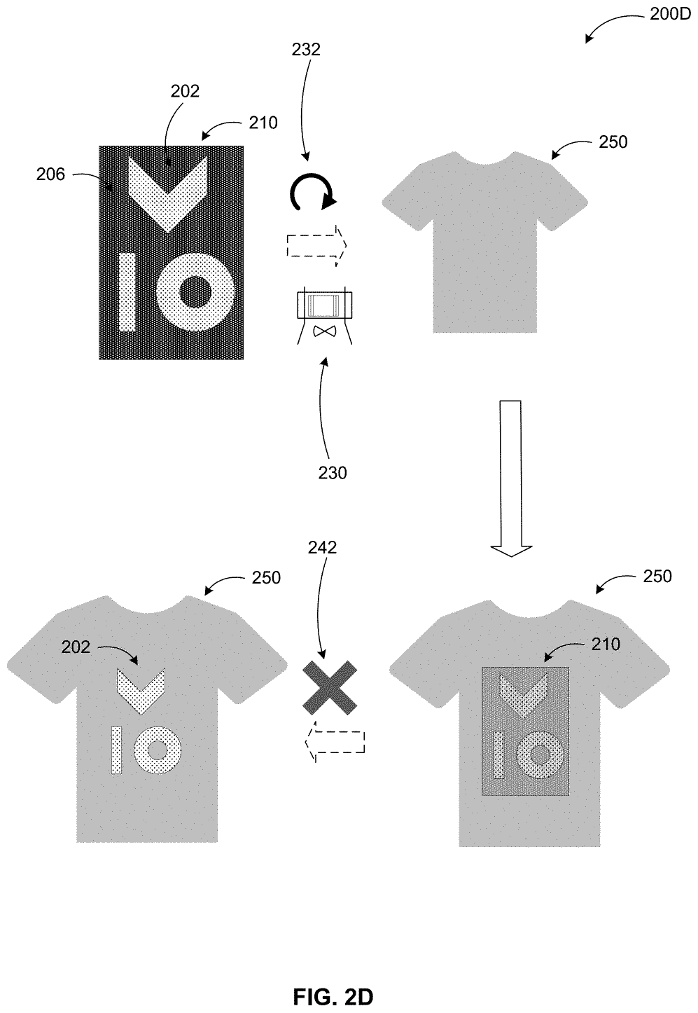

FIG. 2A through 2D include a conceptual illustration of manufacture of a breathable heat transfer label and its application onto a garment, arranged in accordance with at least some embodiments described herein.

Diagram 200A shows one of the initial steps in the manufacturing process, where a label design 202 containing text and graphics is printed in reverse onto a carrier 206 by a printer 204. In the next step shown in diagram 200B, a thermoplastic adhesive 212 is applied (216) by an applicator 214 onto the printed ink layer 202 on the carrier 206. Diagram 200C shows holes 222 being drilled by a laser module 220 in the label 210. The holes may be drilled through the thermoplastic adhesive side such that burn marks do not appear on the other side of the ink surface when it is exposed by removal of the carrier upon application onto a textile item such as a garment.

Diagram 200D shows the label 210 being flipped (232) and attached to garment 250 by activating the thermoplastic adhesive. The thermoplastic adhesive may be activated by applying heat through a heat source 230 (e.g., hot air, UV light, etc.). The carrier 206 may be removed from the label 210 on the garment 250 at removal step 242 leaving the garment 250 with the breathable label design 202 containing laser-drilled holes. In some cases, an additional protective layer (e.g., varnish, flame-retardant materials, etc.) may be applied over the label design upon removal of the carrier 206.

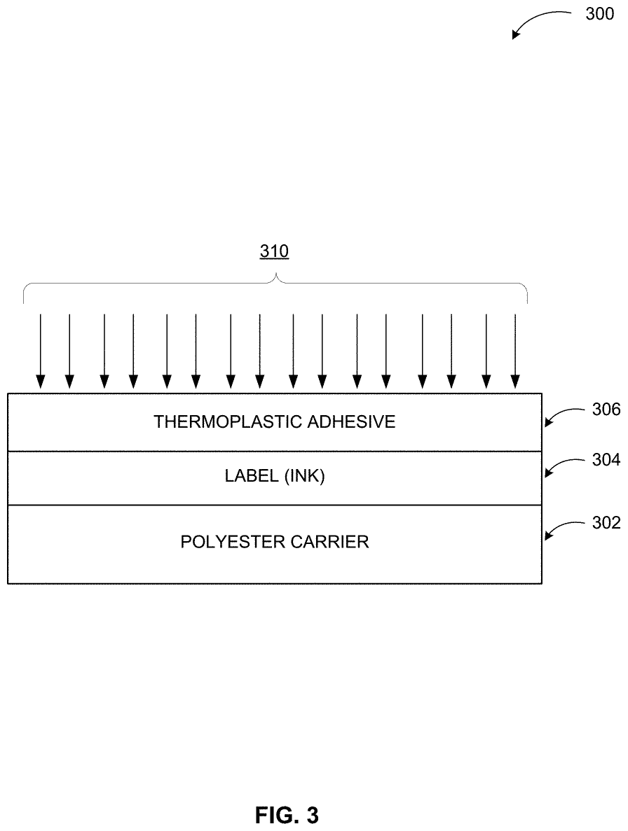

FIG. 3 includes a conceptual illustration of the layers of an example breathable heat transfer label, arranged in accordance with at least some embodiments described herein.

As shown in diagram, polyester carrier 302 may form the substrate of the label to be applied. The label (ink) 304 may form the design on the carrier layer. A thermoplastic adhesive layer 306 may be applied over the ink layer for attachment to a textile item. Ventilation holes may be drilled (310) through the thermoplastic adhesive layer 306 using a laser module, for example. When the label is applied to a textile item (e.g., garment) by activating the thermoplastic adhesive layer 306 and the carrier 302 is removed, the side of the ink layer facing the carrier is exposed. By drilling the holes through the thermoplastic adhesive side, burn marks on the visible surface of the ink layer are avoided.

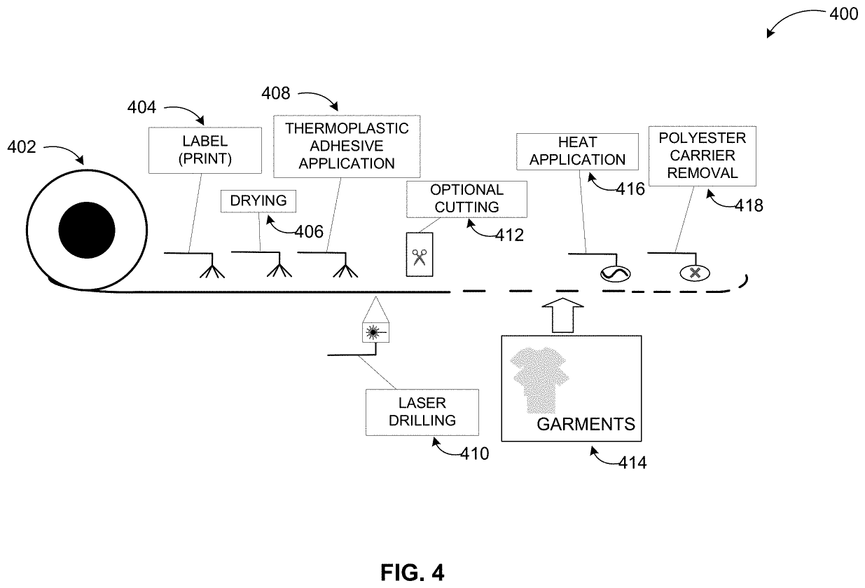

FIG. 4 includes a conceptual illustration of an example system to manufacture garments with breathable heat transfer labels, arranged in accordance with at least some embodiments described herein.

The example manufacturing system shown in diagram 400 may provide the carrier in form of a roll 402 (pre-cut or continuous). The carrier is made from a material that includes satin, nylon, polyester, cotton, silk, recycled polyester, or Polyethylene Terephthalate (PET). A label print module 404 may print the label design onto a surface of the carrier using a water-based or a solvent-based ink. The design may include text, graphics, images, holograms, etc. A type and thickness of the ink may be selected based on the material of the textile item (e.g., garment) to be labeled, design, and expected use conditions (e.g., outdoor garments vs. undergarments, for example). A dryer module 406 may dry the ink on the carrier by applying heat, air, ultraviolet light, or combination thereof. Next, an applicator module 408 may apply the thermoplastic adhesive over the printed ink. The thermoplastic adhesive may be polyester-based, urethane-based, or poly-vinyl-acetate-based. The thermoplastic adhesive may be rolled on, sprayed on, etc. A laser module 410 may drill holes through the applied thermoplastic adhesive. For example, the laser module may be a micro-perforation laser. Drilling the holes on the adhesive side may prevent burn marks to be visible on the printed ink when the label is applied to the textile item. The holes may have a diameter ranging from about 0.05 mm to about 1 mm. A gap between holes may range from about 0.25 mm to about 0.75 mm.

An optional cutter 412 may cut the labels to desired size (in case of continuous carrier applications). The textile item (garments 414) may be provided at the next stage and a heat applicator 416 may activate the thermoplastic adhesive by applying heat. The temperature and duration of the applies heat may depend on the type of ink, carrier, textile item, etc. The carrier may be removed at a removal module 418. The textile item with the breathable label may be checked for quality, processed further (e.g., sewing), and packaged for shipment.

In some example implementations, a thickness of the applied ink may vary between 7 μm and 14 μm . Similarly, the thickness of the applied thermoplastic adhesive may vary between 10 μm and 20 μm. Cutting may be accomplished with stump knifes, using laser, or ultrasonically. An example processing speed for the manufacturing machine may be 6-7 m (of carrier) per minute.

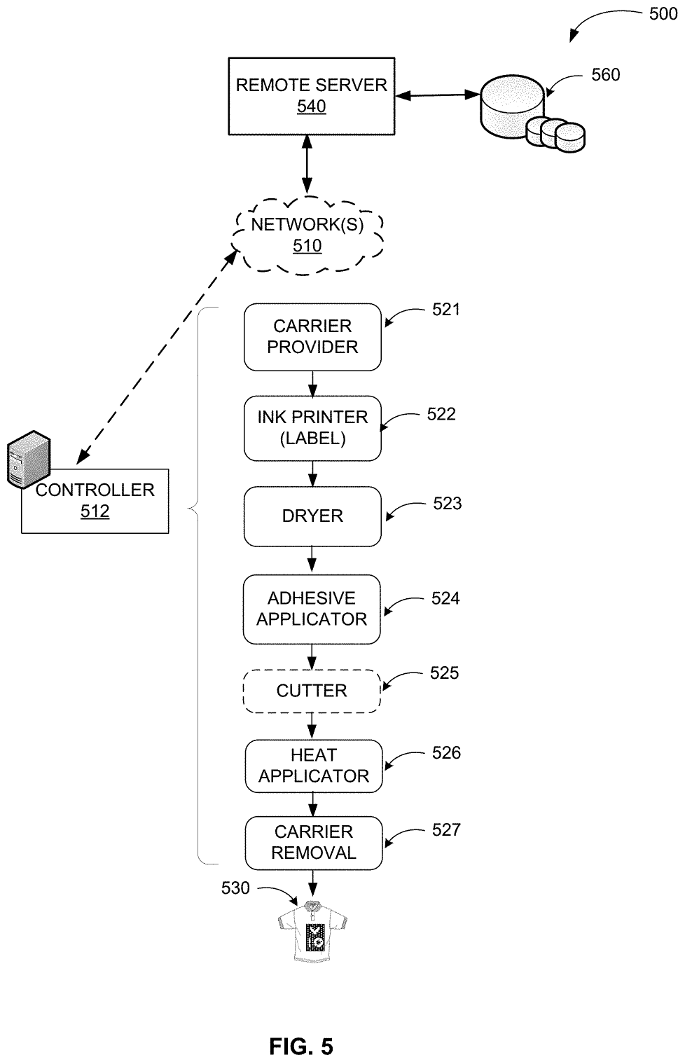

FIG. 5 illustrates major components of an example system for providing garments with breathable heat transfer labels, arranged in accordance with at least some embodiments described herein.

The example system shown in diagram 500 may include a remote server 540 managing operations of a manufacturing system according to embodiments, one or more data stores 560 storing label design data, process data, and similar information. The remote server 540 may communicate with one or more controllers managing the manufacturing system's individual modules such as controller 512 over one or more networks, which may include private, public, wired, wireless, and other forms of networks using any suitable protocols (e.g., terrestrial and/or satellite-based communications or a combination thereof).

The manufacturing system may include individual process modules for following process steps: carrier provider 521, where pre-cut or combined carriers may be provided to the system by a roller, for example. Ink printer 522 may print the predefined design (e.g., graphics, images, holograms, text, etc.) onto the carrier using water-based or solvent-based ink. In some examples, flexography or similar techniques may be used. Dryer 523 may be used to dry the printed ink. Adhesive applicator 524 may apply a thermoplastic adhesive onto the printed ink such as a polyester-based, a urethane-based, or a poly-vinyl-acetate-based adhesive. An optional cutter 525 may cut the labels (in case of combined carriers) and/or the textile items with the applied labels. A heat applicator 526 may apply heat to activate the adhesive. Next, a carrier removal module 527 may remove the carrier revealing the textile item with the applied breathable label.

In some implementations, a quality check process may include checking of the design integrity, hole size/number check, adhesion confirmation, etc. Input devices such as cameras, scanners, etc. may be used for enhanced quality control results. These process steps and modules are illustrative examples, and a manufacturing system according to embodiments may include more or fewer modules and process steps. Each process step may be performed at individually dedicated stations or combined in groups.

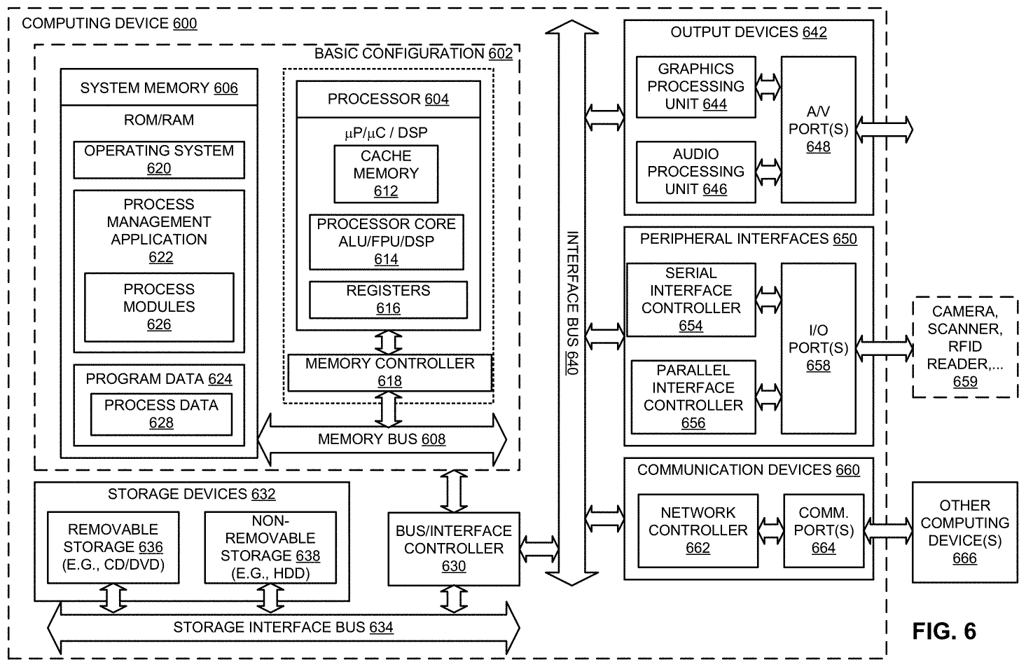

FIG. 6 illustrates a computing device, which may be used to manage a system to manufacture garments with breathable heat transfer labels, arranged in accordance with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a process management application 622, and program data 624. The process management application 622 may include one or more process modules 626. The process management application 622 may be configured to manage the manufacturing process of garments with breathable heat transfer labels through one or more process modules 626, where each module may control the operations of a manufacturing module such as printing of the label design, application of thermoplastic adhesive, drilling of holes, and application of the carrier onto the garment, etc. The program data 624 may include process data 628 such as material types, thicknesses to be applied, etc., as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 650, and one or more communication devices 660) to the basic configuration 602 via the bus/interface controller 630. Some of the example output devices 642 include a graphics processing unit 644 and an audio processing unit 646, which may be configured to communicate to various external devices such as a display or speakers via one or more A/V ports 648. One or more example peripheral interfaces 650 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. In some examples, a camera, a scanner, an RFID reader, or similar devices 659 may be used for quality control processes checking structural and functional aspects of the labels and connecting to the computing device through the I/O ports 658. An example communication device 660 includes a network controller 662, which may be arranged to facilitate communications with one or more other computing devices 666 over a network communication link via one or more communication ports 664. The one or more other computing devices 666 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 600 may be implemented as a part of a specialized server, mainframe, or similar computer that includes any of the above functions. The computing device 600 may also be implemented as a personal computer including both laptop computer and non-laptop computer configurations.

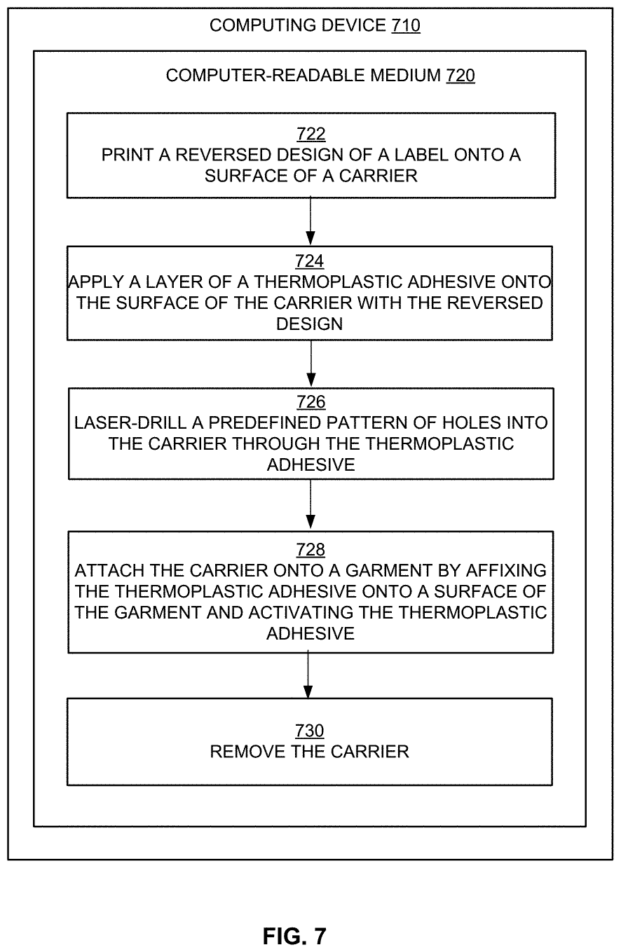

FIG. 7 includes a flowchart of example actions in providing garments with breathable heat transfer labels, arranged in accordance with at least some embodiments described herein.

Example methods may include one or more operations, functions, or actions as illustrated by one or more of blocks 722, 724, 726, 728, and 730 may in some embodiments be performed by a computing device such as the computing device 600 in FIG. 6. Such operations, functions, or actions in FIG. 6 and in the other figures, in some embodiments, may be combined, eliminated, modified, and/or supplemented with other operations, functions or actions, and need not necessarily be performed in the exact sequence as shown. The operations described in the blocks 722-730 may be implemented through execution of computer-executable instructions stored in a computer-readable medium such as a computer-readable medium 720 of a computing device 710.

An example process to provide garments with breathable heat transfer labels may begin with block 722, “PRINT A REVERSED DESIGN OF A LABEL ONTO A SURFACE OF A CARRIER”, where a printer module of a system such as the system described in FIG. 4 may print a reversed version of a label design onto a provided carrier using water-based or solvent-based ink.

Block 722 may be followed by block 724, “APPLY A LAYER OF A THERMOPLASTIC ADHESIVE ONTO THE SURFACE OF THE CARRIER WITH THE REVERSED DESIGN”, where an applicator module of the system may apply a layer of a thermoplastic adhesive onto the surface of the carrier with the reversed design. The thermoplastic adhesive may be polyester-based, urethane-based, or poly-vinyl-acetate-based.

Block 724 may be followed by block 726, “LASER-DRILL A PREDEFINED PATTERN OF HOLES INTO THE CARRIER THROUGH THE THERMOPLASTIC ADHESIVE”, where a laser module of the system may laser-drill a predefined pattern of holes into the carrier through the thermoplastic adhesive. A pattern and/or a size of the holes may be selected to preserve a visual integrity of the design.

Block 726 may be followed by block 728, “ATTACH THE CARRIER ONTO A GARMENT BY AFFIXING THE THERMOPLASTIC ADHESIVE ONTO A SURFACE OF THE GARMENT AND ACTIVATING THE THERMOPLASTIC ADHESIVE”, where an attachment module of the system may attach the carrier onto the textile item (garment) by affixing the thermoplastic adhesive onto a surface of the textile item. The thermoplastic adhesive may be activated by application of heat.

Block 728 may be followed by block 730, “REMOVE THE CARRIER”, where the carrier may be removed revealing the textile item with the applied breathable label. Optionally, quality control check and packaging operations may also be performed.

The operations included in process 700 are for illustration purposes. Garments with breathable heat transfer labels may be implemented by similar processes with fewer or additional operations, as well as in different order of operations using the principles described herein. The operations described herein may be executed by one or more processors operated on one or more computing devices, one or more processor cores, and/or specialized processing devices, among other examples.

According to some examples, a textile item with a breathable heat transfer label is described. The textile item may include a fabric and a label with a graphic design applied to the fabric. The label may be applied through printing of the reversed graphic design onto a surface of a carrier, application of a layer of a thermoplastic adhesive onto the surface of the carrier with the reversed graphic design, laser-drilling of a predefined pattern of holes into the carrier through the thermoplastic adhesive, attachment of the carrier onto the fabric by affixing the thermoplastic adhesive onto a surface of the fabric and activation of the thermoplastic adhesive, and removal the carrier.

According to other examples, the reversed graphic design may be printed onto the surface of the carrier employing a water-based or a solvent-based ink. The carrier may be made from a material that includes satin, nylon, polyester, cotton, silk, recycled polyester, or Polyethylene Terephthalate (PET). The thermoplastic adhesive may be polyester-based, urethane-based, or poly-vinyl-acetate-based. The holes may have a diameter ranging from about 0.05 mm to about 1 mm. A size and a pattern of the holes may be selected to preserve a visual integrity of the graphic design. A shape and a size of the label may be selected based on a type of the textile item and the graphic design. The textile item may be a shirt, a dress, a jacket, a coat, a skirt, a sock, a glove, a scarf, a headgear, an undergarment, shorts, pants, or a sports bag.

According to further examples, a method to manufacture a garment with a breathable heat transfer label is described. The method may include printing a reversed design of a label onto a surface of a carrier; applying a layer of a thermoplastic adhesive onto the surface of the carrier with the reversed design; laser-drilling a predefined pattern of holes into the carrier through the thermoplastic adhesive; attaching the carrier onto a garment by affixing the thermoplastic adhesive onto a surface of the garment and activating the thermoplastic adhesive; and removing the carrier.

According to yet other examples, printing the reversed design of the label onto the surface of a carrier may include employing a water-based or a solvent-based ink. The method may further include cutting the label to a preselected shape and size based on a type of the garment and the design. Laser-drilling the predefined pattern of holes into the carrier may include selecting a diameter of the holes in a range from about 0.05 mm to about 1 mm and selecting a pattern of the holes to preserve a visual integrity of the design. Applying the layer of the thermoplastic adhesive onto the surface of the carrier may include applying a polyester-based, a urethane-based, or a poly-vinyl-acetate-based adhesive.

According to some examples, a system to manufacture a textile item with a breathable heat transfer label is described. The system may include a roller configured to provide a flexible substrate to be used as a carrier; a printer module configured to print a reversed design of a label onto a surface of the carrier; an applicator module configured to apply a layer of a thermoplastic adhesive onto the surface of the carrier with the reversed design; a laser module configured to laser-drill a predefined pattern of holes into the carrier through the thermoplastic adhesive; an attachment module configured to attach the carrier onto textile item by affixing the thermoplastic adhesive onto a surface of the textile item; a heat applicator module configured to activate the thermoplastic adhesive; and a removal module configured to remove the carrier from the surface of the textile item.

According to other examples, the system may further include a dryer module configured to dry the printed design of the label on the surface of the carrier. The laser module may be configured to select a diameter of the holes in a range from about 0.05 mm to about 1 mm and select a pattern of the holes to preserve a visual integrity of the design. The system may also include a cutter module configured to cut the label to a preselected shape and size based on a type of the textile item and the design. The textile item may be a shirt, a dress, a jacket, a coat, a skirt, a sock, a glove, a scarf, a headgear, an undergarment, shorts, pants, or a sports bag. The system may further include a quality control module configured to perform one or more of a structural and a functional quality check on the textile item upon removal of the carrier. The printer module may be configured to employ a water-based or a solvent-based ink to print the reversed design of the label onto the surface of the carrier.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A textile item with a breathable heat transfer label, comprising:
a fabric; and
a label with a graphic design applied to the fabric, wherein the label is applied through:
printing of the reversed graphic design onto a surface of a carrier,
application of a layer of a thermoplastic adhesive onto the surface of the carrier with the reversed graphic design,
laser-drilling of a predefined pattern of holes into the carrier through the thermoplastic adhesive,
attachment of the carrier onto the fabric by affixing the thermoplastic adhesive onto a surface of the fabric and activation of the thermoplastic adhesive, and
removal the carrier.

2. The textile item of claim 1, wherein the reversed graphic design is printed onto the surface of the carrier employing a water-based or a solvent-based ink.

3. The textile item of claim 1, wherein the carrier is made from a material that includes satin, nylon, polyester, cotton, silk, recycled polyester, or Polyethylene Terephthalate (PET).

4. The textile item of claim 1, wherein the thermoplastic adhesive is polyester-based, urethane-based, or poly-vinyl-acetate-based.

5. The textile item of claim 1, wherein the holes have a diameter ranging from about 0.05 mm to about 1 mm.

6. The textile item of claim 1, wherein a size and a pattern of the holes is selected to preserve a visual integrity of the graphic design.

7. The textile item of claim 1, wherein a shape and a size of the label is selected based on a type of the textile item and the graphic design.

8. The textile item of claim 1, wherein the textile item is a shirt, a dress, a jacket, a coat, a skirt, a sock, a glove, a scarf, a headgear, an undergarment, shorts, pants, or a sports bag.

9. A method to manufacture a garment with a breathable heat transfer label, the method comprising:
printing a reversed design of a label onto a surface of a carrier;
applying a layer of a thermoplastic adhesive onto the surface of the carrier with the reversed design;
laser-drilling a predefined pattern of holes into the carrier through the thermoplastic adhesive;
attaching the carrier onto a garment by affixing the thermoplastic adhesive onto a surface of the garment and activating the thermoplastic adhesive; and
removing the carrier.

10. The method of claim 9, wherein printing the reversed design of the label onto the surface of a carrier comprises:
employing a water-based or a solvent-based ink.

11. The method of claim 9, further comprising:
cutting the label to a preselected shape and size based on a type of the garment and the design.

12. The method of claim 9, wherein laser-drilling the predefined pattern of holes into the carrier comprises:
selecting a diameter of the holes in a range from about 0.05 mm to about 1 mm; and
selecting a pattern of the holes to preserve a visual integrity of the design.

13. The method of claim 9, wherein applying the layer of the thermoplastic adhesive onto the surface of the carrier comprises:
applying a polyester-based, a urethane-based, or a poly-vinyl-acetate-based adhesive.

14. A system to manufacture a textile item with a breathable heat transfer label, the system comprising:
a roller configured to provide a flexible substrate to be used as a carrier;
a printer module configured to print a reversed design of a label onto a surface of the carrier;
an applicator module configured to apply a layer of a thermoplastic adhesive onto the surface of the carrier with the reversed design;
a laser module configured to laser-drill a predefined pattern of holes into the carrier through the thermoplastic adhesive;
an attachment module configured to attach the carrier onto textile item by affixing the thermoplastic adhesive onto a surface of the textile item;
a heat applicator module configured to activate the thermoplastic adhesive; and
a removal module configured to remove the carrier from the surface of the textile item.

15. The system of claim 14, further comprising:
a dryer module configured to dry the printed design of the label on the surface of the carrier.

16. The system of claim 14, wherein the laser module is configured to:
select a diameter of the holes in a range from about 0.05 mm to about 1 mm; and
select a pattern of the holes to preserve a visual integrity of the design.

17. The system of claim 14, further comprising:
a cutter module configured to cut the label to a preselected shape and size based on a type of the textile item and the design.

18. The system of claim 14, wherein the textile item is a shirt, a dress, a jacket, a coat, a skirt, a sock, a glove, a scarf, a headgear, an undergarment, shorts, pants, or a sports bag.

19. The system of claim 14, further comprising:
a quality control module configured to perform one or more of a structural and a functional quality check on the textile item upon removal of the carrier.

20. The system of claim 14, wherein the printer module is configured to employ a water-based or a solvent-based ink to print the reversed design of the label onto the surface of the carrier.
